(19) United States
(12) Patent Application Publication
(10) Pub. No.: US 2025/0121302 A1
(43) Pub. Date: Apr. 17, 2025

(54) SYSTEM FOR MEASURING FINE PARTICLES IN LIQUID, METHOD FOR MEASURING FINE PARTICLES IN LIQUID, AND HOLLOW FIBER DEAERATION MODULE

(71) Applicant: DIC Corporation, Tokyo (JP)

(72) Inventors: Kazuyasu Kawashima, Ichihara-shi (JP); Akira Sato, Ichihara-shi (JP); Kazumi Oi, Ichihara-shi (JP); Mana Koyama, Ichihara-shi (JP)

(73) Assignee: DIC Corporation, Tokyo (JP)

(21) Appl. No.: 18/701,965

(22) PCT Filed: Oct. 20, 2022
(86) PCT No.: PCT/JP2022/039121

§ 371 Date: Apr. 17, 2024

(30) Foreign Application Priority Data
Oct. 26, 2021 (JP) 2021-174569

(51) Int. Cl. B01D 19/00; B01D 63/02; B01D 71/26; B01D 71/36; G01N 15/14; G01N 15/1409

(52) U.S. Cl. CPC B01D 19/0031; B01D 63/02; B01D 71/26; B01D 71/36; G01N 15/1409; B01D 2313/04; B01D 2313/13; G01N 2015/1486

(57) ABSTRACT

Provided is a hollow fiber deaeration module excellent in both smoothness of a wetted surface and deaeration performance. More specifically, the hollow fiber deaeration module includes: a closed container; a tube unit disposed in the closed container and composed by bundling a plurality of tubes; a first connector part disposed at a liquid introduction port of the closed container so as to penetrate through the inside and the outside of the closed container and engaged with the closed container; and a second connector part disposed at a liquid discharge port of the closed container so as to penetrate through the inside and the outside of the closed container and engaged with the closed container. The tube in the hollow fiber deaeration module is an amorphous fluoropolymer, polytetrafluoroethylene, or polymethyl pentene.

### TECHNICAL FIELD

The present invention relates to a liquid-borne fine particle counting system and a liquid-borne fine particle counting method using same, and a hollow fiber deaeration module using the system.

### BACKGROUND ART

In semiconductor industry, material industry related thereto, and the like, liquid-borne fine particle counters that utilize a light (lase light) scattering method are widely used for controlling cleanliness of liquids such as water and chemical solutions. In particular, fine particles with diameters of 30 nm or less and further in the order of 10 nm are required to be controlled with miniaturization of elements in semiconductor industry, recently. However, a problem of false counting (false count) in which when fine particles with such a particle diameter are measured with a liquid-borne fine particle counter, bubbles arising from, for example, dissolved oxygen in liquid also scatter light as with fine particles and thus are also counted as fine particles, arises.

PTL 1 describes a liquid-borne fine particle counting system, including a hollow fiber deaeration module for deaerating a liquid to be measured using a PFA tube unit in which a plurality of PFA tubes is bundled, and a liquid-borne fine particle counting means for counting liquid-borne fine particles in the deaerated liquid to be measured. However, the PFA tubes used in this apparatus have the problem of deteriorating deaeration performance although having excellent smoothness. Smoothness of a wetted surface and deaeration performance have a trade-off relationship, and decrease in smoothness of a wetted surface causes fine particles to remain; therefore, the effective length of the tubes has been required to be lengthened so as to secure excellent smoothness.

In addition, although smoothness is defined as inner surface roughness Rt (the maximum cross-section height of a roughness curve, and the sum of the maximum value of a peak height Zₚ and the maximum value of a trough depth Zᵥ of a contour curve in an evaluation length) in the range of 0.4 μm or less in PTL 1, the Rt value has a problem of being easily influenced by disturbance such as scratches, dust, and noise in measurement since the Rt value utilizes a peak value, and excellent smoothness is not always secured within said range.

### CITATION LIST

### Patent Literature

PTL 1: JP2021-15111

### SUMMARY OF INVENTION

### Technical Problem

Thus, a problem to be solved by the invention is to provide a hollow fiber deaeration module used for a liquid-borne fine particle counting system, the hollow fiber deaeration module being excellent in both smoothness of a wetted surface and deaeration performance. Furthermore, an object to be solved by the invention is to provide a liquid-borne fine particle counting system and a liquid-borne fine particle counting method using same, in which false counting (false count) can be suppressed by preventing fine particles from remaining on a wetted surface while efficiently removing bubbles from a liquid to be measured, using such a hollow fiber deaeration module.

### Solution to Problem

As a result of intensive studies to solve the above problems, the present inventors have found that a hollow fiber deaeration module using a tube made from: an amorphous fluororesin including a copolymer obtained from tetrafluoroethylene and perfluoro-2,2-dimethyl-1,3-dioxol comonomers; polytetrafluoroethylene; or polymethylpentene can solve the above problems to complete the present invention.

That is, the invention relates to [1] a liquid-borne fine particle counting system having a liquid-borne fine particle counter and at least one hollow fiber deaeration module connected to a flow channel between a supply source of a liquid for fine particle counting and a liquid introduction port of the liquid-borne fine particle counter, in which
the hollow fiber deaeration module has
a closed container,
a tube unit disposed in the closed container and composed of one tube or by bundling two or more tubes,
a first connector part disposed at a liquid introduction port of the closed container so as to penetrate through the inside and the outside of the closed container and engaged with the closed container, and
a second connector part disposed at a liquid discharge port of the closed container so as to penetrate through the inside and the outside of the closed container and engaged with the closed container;
one end part of the tube or the tube unit is airtightly connected to the first connector part;
the other end part of the tube or the tube unit is airtightly connected to the second connector part; and
the tube is formed from one or more kinds selected from an amorphous fluoropolymer, polytetrafluoroethylene, and polymethyl pentene.

The invention also relates to [2] the liquid-borne fine particle counting system according to [1] above, in which the first connector part or the second connector part is formed from one or more kinds selected from: an amorphous fluororesin including a copolymer obtained from tetrafluoroethylene and perfluoro-2,2-dimethyl-1,3-dioxol comonomers; a tetrafluoroethylene resin; and a polymethylpentene resin.

The invention also relates to [3] the liquid-borne fine particle counting system according to [1] or [2] above, in which surface roughness Ra of a wetted surface of the tube is 0.25 μm or less, and the tube has a gas permeability coefficient falling within a range of 5×10^{-6 [}cm³·cm/cm²·sec·cmHg] to 1×10^{-9 [}cm³·cm/cm²·sec·cmHg].

The invention also relates to [4] the liquid-borne fine particle counting system according to any of [1] to [3] above, in which the first connector part has: a first connector part main body in which a first through-flow channel is formed; a first concave part which is provided to one end part of the first connector part main body in relation to an axis line direction of the first through-flow channel and to which a flow channel on the liquid supply source side is connected; a second concave part which is provided to the other end part of the first connector part main body and to which one end part of the tube unit is connected; and an engaging part provided in an outer peripheral part of the first connector part main body.

The invention also relates to [5] the liquid-borne fine particle counting system according to any of [1] to [4] above, in which the first connector part has at least one seal part selected from the group consisting of: a first seal part disposed between the first connector part main body and the closed container; a second seal part disposed in the second concave part; and a notch part provided in the other end part of the first connector part main body and an annular third seal part disposed in the notch part.

The invention also relates to [6] the liquid-borne fine particle counting system according to any of [1] to [5] above, in which the second connector part has: a second connector part main body in which a second through-flow channel is formed; a first concave part which is provided to one end part of the second connector part main body in relation to an axis line direction of the second through-flow channel and to which a flow channel connected to the liquid introduction port of the liquid-borne fine particle counter is connected; a second concave part which is provided to the other end part of the second connector part main body and to which one end part of the tube unit is connected; and an engaging part provided in an outer peripheral part of the second connector part main body.

The present invention also relates to [7] the liquid-borne fine particle counting system according to any of [1] to [6] above, in which the second connector part has at least one seal part selected from the group consisting of: a first seal part disposed between the second connector part main body and the closed container; a second seal part disposed in the second concave part; and a notch part provided in the other end part of the second connector part main body and an annular third seal part disposed in the notch part.

The invention also relates to [8] a liquid-borne fine particle counting method characterized in that fine particles in a liquid is counted using the liquid-borne fine particle counting system according to any of [1] to [7] above.

The invention also relates to [9] a hollow fiber deaeration module used for a liquid-borne fine particle counting system, the hollow fiber deaeration module including:
a closed container,
a tube unit disposed in the closed container and composed of one tube or by bundling two or more tubes,
a first connector part disposed at a liquid introduction port of the closed container so as to penetrate through the inside and the outside of the closed container and engaged with the closed container, and
a second connector part disposed at a liquid discharge port of the closed container so as to penetrate through the inside and the outside of the closed container and engaged with the closed container; in which one end part of the tube or the tube unit is airtightly connected to the first connector part;
the other end part of the tube or the tube unit is airtightly connected to the second connector part; and
the tube is formed from one or more kinds selected from an amorphous fluoropolymer, polytetrafluoroethylene, and polymethyl pentene.

### Advantageous Effects of Invention

According to the invention, a hollow fiber deaeration module which is used for a liquid-borne fine particle counting system and is excellent in both smoothness of a wetted surface and deaeration performance can be provided. Furthermore, according to the invention, a liquid-borne fine particle counting system and a liquid-borne fine particle counting method using same, in which false counting (false count) can be suppressed by preventing fine particles from remaining on a wetted surface while efficiently removing bubbles from a liquid to be measured, can be provided using such a hollow fiber deaeration module.

### BRIEF DESCRIPTION OF DRAWINGS

FIG. 1 is a conceptual diagram illustrating one example of a liquid-borne fine particle counting system of the invention.

FIG. 2 is a schematic cross-sectional view illustrating one example of a hollow fiber deaeration module of the invention.

FIG. 3(a) is an enlarged cross-sectional view illustrating a configuration of a first connector part of FIG. 2, and FIG. 3(b) is an enlarged cross-sectional view illustrating a configuration of a second connector part of FIG. 2.

FIG. 4 is a schematic perspective view illustrating one example of a tube unit used in the invention.

FIG. 5(a) is a schematic cross-sectional view illustrating a modification of the first connector part of FIG. 3(a), and FIG. 5(b) is an enlarged partial cross-sectional view.

FIG. 6(a) is a schematic cross-sectional view illustrating a modification of the second connector part of FIG. 3(b), and FIG. 6(b) is an enlarged partial cross-sectional view.

### DESCRIPTION OF EMBODIMENTS

Hereinbelow, one embodiment of the invention is described with reference to the drawings.

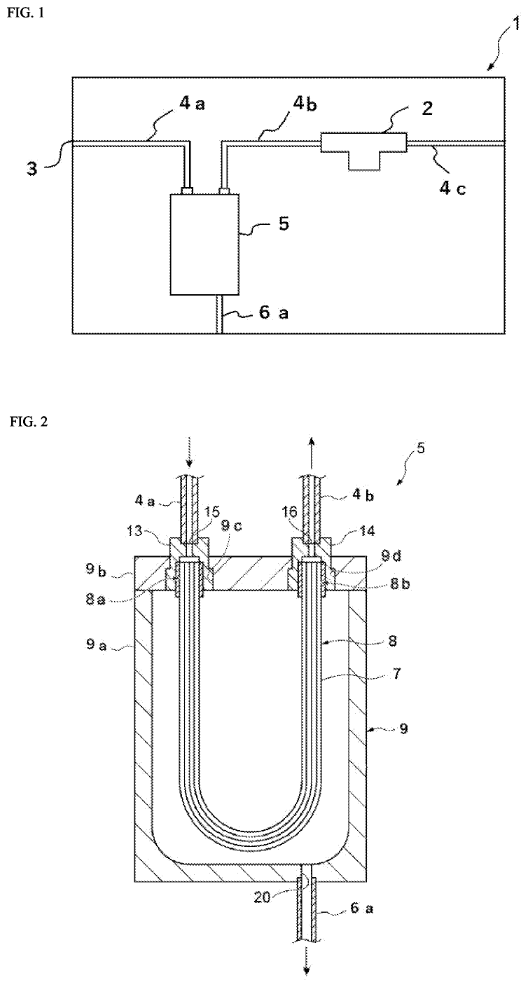

FIG. 1 is a conceptual diagram illustrating one example of a liquid-borne fine particle counting system of the invention. The liquid-borne fine particle counting system 1 of the invention has a liquid-borne fine particle counter 2 and at least one hollow fiber deaeration module 5 connected to a flow channel (4a, 4b) between a supply source 3 of a liquid for fine particle counting and a liquid introduction port of the liquid-borne fine particle counter.

The liquid-borne fine particle counter used in the invention may be a known liquid-borne fine particle counter, and examples thereof include a liquid-borne fine particle counter employing a method (light scattering method) of counting the number of fine particles included in a liquid by irradiating the liquid with light and detecting scattering and reduction of the energy of the light.

The hollow fiber deaeration module 5 used in the invention is connected to a flow channel between the supply source 3 of a liquid for fine particle counting and a liquid introduction port of the liquid-borne fine particle counter 2. In addition, a suction pump 6 is connected to the hollow fiber deaeration module 5 via piping 6a for deaeration so that the liquid for fine particle counting can be deaerated.

FIG. 2 is a schematic cross-sectional view illustrating one example of the hollow fiber deaeration module. As illustrated in FIG. 2, the hollow fiber deaeration module 5 has a closed container 9, a tube unit 8 disposed in the closed container 9 and composed by bundling a plurality of tubes 7, a first connector part 13 which is disposed at a liquid introduction port 9c of the closed container 9 so as to penetrate through the inside and the outside of the closed container 9 and which is engaged with the closed container 9, and a second connector part 14 which is disposed at a liquid discharge port 9d of the closed container 9 so as to penetrate through the inside and the outside of the closed container 9 and which is engaged with the closed container 9. The inside of the closed container 9 of the hollow fiber deaeration module 5 is divided, by the plurality of tubes 7, into an internal space (first region) of each of the tubes 7 and an external space (second region) of the plurality of tubes 7. The first region is a region to which liquid is supplied, and the second region is a region from which air is suctioned. The hollow fiber deaeration module 5 has a structure in which a liquid is supplied to the internal space (first region) of each of the tubes 7 and the liquid is deaerated by suctioning air from the external space (second region) of the plurality of tubes 7.

In addition, it is preferable that each tube employ a close-packed structure (honeycomb) as the cross-sectional surface of the tube unit 8 composed by bundling both end parts of the plurality of tubes 7. Furthermore, the cross-sectional surface of the tube unit 8 is more preferably a hexagonal shape. Incidentally, a hexagonal cross-sectional surface of the tube unit means that a line (imaginative line) connecting the centers of the plurality of tubes disposed on the outer side forms a hexagonal shape. Accordingly, in the case where the cross-sectional surface is hexagonal, the total number of the tubes may be a number represented by ¼×{3(2n+1)²+1}. Provided that n is a natural number, the lower limit thereof is 1, and the upper limit thereof is not defined but is preferably 6, in the formula. Incidentally, although the number of tubes constituting the tube unit is described as being 2 or more in the embodiment described above, the number of tubes constituting the tube unit may be one.

The tube 7 is a tubular membrane that allows gas to permeate therethrough and allows no liquid to permeate therethrough. Examples of the material for the tube 7 used in the invention include one or more kinds selected from polytetrafluoroethylene (hereinafter, also referred to as PTFE), an amorphous fluoropolymer, and polymethylpentene (hereinafter, also referred to as PMP). More specifically, the amorphous fluoropolymer (hereinafter, also referred to as “Teflon (registered trademark) AF”) may be an amorphous fluororesin including a copolymer obtained from tetrafluoroethylene and perfluoro-2,2-dimethyl-1,3-dioxol comonomers. These materials maintain original smoothness of resin and also have good bubble and gas permeability, and thus can further shorten the effective length. Therefore, fine particles can be prevented from accumulating in the tube, and high-accuracy measurement becomes possible.

Furthermore, when the tube is made from an amorphous fluoropolymer, the inner diameter of the tube preferably falls within the range of 0.015 mm or more and 1.0 mm or less. In addition, the effective length of the tube preferably falls within the range of 0.01 m or more and 1.5 m or less. Furthermore, it is more preferable that the number of tubes constituting the tube unit be one, and the inner diameter of the tube fall within the range of 0.8 mm or more and 1.0 mm or less, and it is more preferable that the number of tubes constituting the tube unit fall within the range of 2 or more and 30 or less, and the inner diameter of the tubes fall within the range of 0.045±0.03 mm or more and 0.68±0.03 mm or less.

In addition, when the tube is made from PTFE, it is preferable that the number of tubes constituting the tube unit fall within the range of 10 or more and 20 or less, the inner diameter of the tubes fall within the range of 0.4 mm or more and 0.6 mm or less, and the effective length fall within the range of 1 m or more and 2 m or less. In addition, when the tube is made from PMP, it is preferable that the number of tubes constituting the tube unit be one, the inner diameter of the tube fall within the range of 0.1 mm or more and 0.2 mm or less, and the effective length fall within the range of 0.01 m or more and 1.5 m or less.

Arithmetic average roughness Ra of a surface of the tube used in the invention in contact with the liquid to be measured, that is, a wetted surface of the tube is preferably 0.25 μm or less, more preferably 0.1 μm or less, still more preferably 0.07 μm or less, and especially preferably 0.02 μm or less. By virtue of using the above-described materials, the tube used in the invention has such excellent smoothness and thus can suppress false counting (false count) due to influence of disturbance or the like, and is preferable. Incidentally, the arithmetic average roughness Ra is a number average value of values obtained by measuring surfaces in contact with the liquid to be measured of arbitrarily selected 10 tubes used in the invention, in accordance with ISO4287: 1997, taking 20 μm as a reference length.

In addition, the gas permeability coefficient of the tube used in the invention preferably falls within a range of 5×10^{-6 [}cm³·cm/cm²·sec·cmHg] or more and 1×10^{-9 [}cm³·cm/cm²·sec·cmHg] or less.

The tube unit 8 may be composed by bundling both end parts of the plurality of tubes 7. That is, the tube unit 8 may include the plurality of tubes 7 and a pair of bundling parts 10a and 10b respectively bundling an end part on one side and an end part on the other side of the plurality of tubes 7. Incidentally, the pair of bundling parts 10a and 10b may be parts attached to the closed container 9.

The bundling parts 10a and 10b may be configured to include an outer cylinder 11a or 11b externally fitted to each end part of the plurality of tubes 7, and a sealing part 12a or 12b filling the gap between each end part of the plurality of tubes 7 and the outer cylinder 11a or 11b, respectively.

The outer cylinders 11a and 11b are formed into an approximately cylindrical shape to form the outermost layers of the bundling parts 10a and 10b. The outer cylinders 11a and 11b are parts attached to the closed container 9. Examples of materials for the outer cylinders 11a and 11b include a fluororesin such as PTFE, an amorphous fluoropolymer, a tetrafluoroethylene-perfluoroalkyl vinyl ether copolymer (hereinafter, also referred to as PFA), a tetrafluoroethylene-hexafluoropropylene copolymer (hereinafter, also referred to as FEP), a tetrafluoroethylene-ethylene copolymer (hereinafter, also referred to as ETFE), polychlorotrifluoroethylene (hereinafter, also referred to as PCTFE), and polyvinylidene fluoride (hereinafter, also referred to as PVDF); an olefin resin such as PMP and polypropylene (hereinafter, also referred to as PP); a silicone resin; a polyimide resin; and a polyamide resin. It is preferable that the same material be employed for the cylinders 11a and 11b as for the tube 7.

The sealing parts 12a and 12b fill the gaps between the end parts of the plurality of tubes 7 and the outer cylinders 11a and 11b to bundle the end parts of the plurality of tubes 7 and seal the gaps between the end parts of the plurality of tubes 7 and the outer cylinders 11a and 11b. That is, the sealing parts 12a and 12b do not fill the internal space of each of the tubes 7 and fill a gap between the tubes 7 and the gaps between the plurality of tubes 7 and the outer cylinders 11a and 11b (see FIG. 4). Therefore, only the internal space of each of the tubes 7 opens from the end faces of the sealing parts 12a and 12b. The same materials as those exemplified for the outer cylinders 11a and 11b can be used as materials for the sealing parts 12a and 12b. Examples thereof include a fluororesin such as PTFE, an amorphous fluoropolymer, PMP, PFA, FEP, ETFE, polychlorotrifluoroethylene (hereinafter, also referred to as PCTFE), and polyvinylidene fluoride (hereinafter, also referred to as PVDF); polypropylene (hereinafter, also referred to as PP); a silicone; a polyimide; and a polyamide. It is preferable that the same material as for the tube 7 be employed.

In the present embodiment, one end part 8a of the tube unit 8 (or the tube 7) is airtightly connected to the first connector part 13 disposed at the liquid introduction port 9c of the closed container 9, and the other end part 8b of the tube unit 8 (or the tube 7) is airtightly connected to the second connector part 14 disposed at the liquid discharge port 9d of the closed container 9. By virtue of such a structure, airtightness between the closed container 9 and each of the first connector part 13 and the second connector part 14 can be maintained, and high airtightness between the tube unit 8 (or the tube 7) and each of the first connector part 13 and the second connector part 14 can be simultaneously maintained for a long period. In addition, when compared with a configuration in which a flow channel between a supply source and a liquid introduction port of the liquid-borne fine particle counter is directly connected to a closed container, excellent airtightness can be provided; in addition, the degree of freedom in design of the first and second connector parts is high, and further improvement in airtightness can be easily provided.

Hereinbelow, one embodiment of the closed container 9 will be described based on FIG. 2. The closed container 9 includes a container main body 9a and a lid part 9b.

The container main body 9a is a part in which the tube unit 8 is accommodated. The container main body 9a is a cylindrical container having an opening on one end face thereof. The lid part 9b is a lid airtightly joined to the container main body 9a to close the opening of the container main body 9a. The lid part 9b can be joined to the container main body 9a through welding, screwing, engagement, and the like, for example. Incidentally, the closed container 9 may be integrally formed without being separated into the container main body 9a and the lid part 9b, in a case where there is no production problem.

In the present embodiment, the first connector part 13 and the second connector part 14 are airtightly joined to the lid part 9b. A first through-flow channel 15 penetrating through the inside and the outside of the lid part 9b (closed container 9) is formed in the first connector part 13, and a second through-flow channel 16 penetrating through the inside and the outside of the lid part 9b (closed container 9) is formed in the second connector part 14. The lid part 9b can be joined to the first connector part 13 and the second connector part 14 through welding, screwing, engagement, and the like, for example.

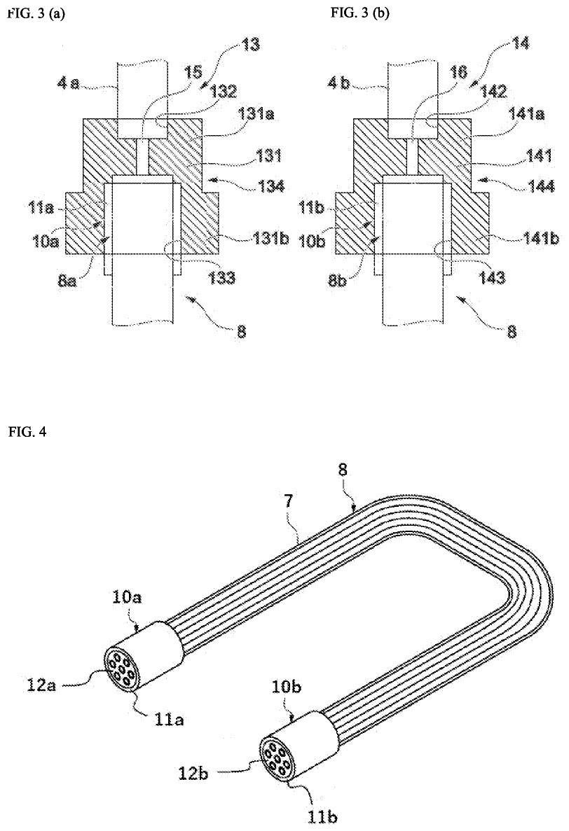

As illustrated in FIG. 3(a), the first connector part 13 has a first connector part main body 131 in which the first through-flow channel 15 is formed, a first concave part 132 which is provided to one end part 131a of the first connector part main body 131 in relation to an axis line direction of the first through-flow channel 15 and to which a flow channel 4a on the liquid supply source 3 side is connected, a second concave part 133 which is provided to the other end part 131b of the first connector part main body 131 and to which one end part 8a of the tube unit 8 is connected, and an engaging part 134 provided in an outer peripheral part of the first connector part main body 131.

As illustrated in FIG. 3(b), the second connector part 14 has a second connector part main body 141 in which the second through-flow channel 16 is formed, a third concave part 142 which is provided to one end part 141a of the second connector part main body 141 in relation to an axis line direction of the second through-flow channel 16 and to which a flow channel 4b on the liquid introduction port side of the liquid-borne fine particle counter 2 is connected, a fourth concave part 143 which is provided to the other end part 141b of the second connector part main body 141 and to which the other end part 8b of the tube unit 8 is connected, and an engaging part 144 provided in an outer peripheral part of the second connector part main body 141.

The flow channel 4a is inserted into the first concave part 132 of the first connector part 13, and the flow channel 4a and the first through-flow channel 15 communicate with each other when the first concave part 132 and the flow channel 4a are joined. This structure can prevent misalignment of a core and can prevent flow channel blockage and increase in pressure loss. In addition, one end part 8a of the tube unit 8 is inserted into the second concave part 133 of the first connector part 13 together with the bundling part 10a, and when the first connector part main body 131 and one bundling part 10a of the tube unit 8 airtightly joined, the first connector part 13 and the tube unit 8 are airtightly connected. This structure can prevent misalignment of a core and can prevent flow channel blockage and increase in pressure loss. Furthermore, the internal space of each of the tubes 7 communicates with the flow channel 4a via the first through-flow channel 15 thereby. The engaging part 134 is, for example, a stepped part disposed between the one bundling part 10a of the tube unit 8 and the closed container 9. This stepped part may be formed between an enlarged diameter part on one end side in the axis line direction of the first connector part main body 131 having a cylindrical shape and a reduced diameter part on the other end side, for example. The above-described configuration of the first connector part 13 can further improve airtightness between the first connector part 13 and the closed container 9. The first connector part 13 can be joined to the flow channel 4a through welding, screwing, engagement, and the like, for example. In addition, the first connector part 13 can be joined to the one bundling part 10a of the tube unit 8 through welding, screwing, engagement, and the like, for example.

The flow channel 4b is inserted into the third concave part 142 of the second connector part 14, and the flow channel 4b and the second through-flow channel 16 communicate with each other when the third concave part 142 and the flow channel 4b are joined. This structure can prevent misalignment of a core and can prevent flow channel blockage and increase in pressure loss. In addition, the other end part 8b of the tube unit 8 is inserted into the fourth concave part 143 of the second connector part 14 together with the bundling part 10b, and when the second connector part main body 141 and the other bundling part 10b of the tube unit 8 are airtightly joined, the second connector part 14 and the tube unit 8 are airtightly connected. This structure can prevent misalignment of a core and can prevent flow channel blockage and increase in pressure loss. Furthermore, the internal space of each of the tubes 7 communicates with the flow channel 4b via the second through-flow channel 16 thereby. The engaging part 144 is, for example, a stepped part disposed between the other bundling part 10b of the tube unit 8 and the closed container 9. This stepped part may be formed between a reduced diameter part on one end side in the axis line direction of the second connector part main body 141 having a cylindrical shape and an enlarged diameter part on the other end side, for example. The above-described configuration of the second connector part 14 can further improve airtightness between the second connector part 14 and the closed container 9. The second connector part 14 can be joined to the flow channel 4b through welding, screwing, engagement, and the like, for example. In addition, the second connector part 14 can be joined to the other bundling part 10b of the tube unit 8 through welding, screwing, engagement, and the like, for example.

The first connector part 13 is preferably formed from one or more kinds selected from an amorphous fluororesin including a copolymer obtained from tetrafluoroethylene and perfluoro-2,2-dimethyl-1,3-dioxol comonomers; a tetrafluoroethylene resin; and a polymethyl pentene resin. Similarly, the second connector part 14 is preferably formed from one or more kinds selected from an amorphous fluororesin including a copolymer obtained from tetrafluoroethylene and perfluoro-2,2-dimethyl-1,3-dioxol comonomers; a tetrafluoroethylene resin; and a polymethyl pentene resin.

It is preferable that the same material be employed for the first connector part 13 and the second connector part 14 as for the tube 7, and it is more preferable that the same material be also used for the outer cylinders 11a and 11b constituting the bundling parts 10a and 10b and/or the sealing parts 12a and 12b. This configuration is preferable, because when the same material is used for the above-described parts, linear expansion coefficients are uniformed, improving adhesiveness and airtightness, and besides, in cooperation with the structure in which the bundling part 10a is inserted into the second concave part 133 or with the structure in which the bundling part 10b is inserted into the second concave part 143, false counting (false count) due to influence of disturbance or the like can be suppressed by preventing a gap from generating at the joined surface as joined parts follow each other, and thereby preventing bubbles from accumulating even when a deformation such as expansion or shrinkage is caused in the material due to a change in temperature or a change in pressure, for example.

A suction port 20 may be formed in the container main body 9a. The suction port 20 is an opening formed in the container main body 9a so as to suction air from a space outside the plurality of tubes 7 inside the closed container 9. The piping 6a communicating with the space outside the plurality of tubes 7 inside the closed container 9 may be joined to the suction port 20. Consequently, the space outside the plurality of tubes 7 inside the closed container 9 can be depressurized by connecting the suction pump 6 to the piping 6a and suctioning air from the suction port 20 by means of the suction pump 6. The piping 6a can be joined to the suction port 20 through welding, screwing, engagement, and the like, for example.

In a case where a liquid is deaerated using the hollow fiber deaeration module 5 having such a configuration, the liquid is supplied to the flow channel 4a and the liquid is discharged from the flow channel 4b, while suctioning air from the space outside the plurality of tubes 7 inside the closed container 9 using the suction pump 6 connected to the piping 6a. The liquid supplied to the flow channel 4a is thus supplied to the internal space of each of the tubes 7 via the first connector part 13. At this time, since the space outside the plurality of tubes 7 inside the closed container 9 is in a state of being depressurized, dissolved gas and bubbles in the liquid permeate each of the tubes 7 and are drawn into the space outside the plurality of tubes 7 inside the closed container 9 as the liquid passes through the internal space of each of the tubes 7. The liquid is deaerated thereby. The deaerated liquid is then discharged to the flow channel 4b via the second connector part 14.

The flow channels 4a and 4b each may be a tube. The flow channels 4a and 4b are preferably formed from one or more kinds selected from an amorphous fluororesin including a copolymer obtained from tetrafluoroethylene and perfluoro-2,2-dimethyl-1,3-dioxol comonomers; a tetrafluoroethylene resin; and a polymethylpentene resin. It is preferable that the same material be employed for the flow channels 4a and 4b as for the tube 7. This configuration is preferable, because when the same material is used, linear expansion coefficients are uniformed, and it is a structure which the flow channel 4a and the flow channel 4b are inserted into the first recessed part 132 and the third recessed part 142, respectively, false counting (false count) due to influence of disturbance or the like can be suppressed by preventing a gap from generating at the joined surface as joined parts follow each other, and thereby preventing bubbles from accumulating even when a deformation such as expansion or shrinkage is caused in the material due to a change in temperature or a change in pressure, for example.

In addition, when one end part of the plurality of tubes 7 is separated from the other end, the end parts of the plurality of tubes 7 are covered with the sealing parts 12a and 12b, respectively. Fluid can be prevented from leaking from the boundary surface of each end part of the plurality of tubes 7 thereby.

Then, in the hollow fiber deaeration module 5 according to the present embodiment, by virtue of supplying the liquid to the first through-flow channel 15 of the liquid introduction port 9c and discharging the liquid from the liquid from the second through-flow channel 16 of the liquid discharge port 9d while suctioning air from the suction port 20, the liquid supplied to the first through-flow channel 15 is deaerated during passing through the plurality of tubes 7 and discharged from the second through-flow channel 16. Then, bundling strength of the plurality of tubes 7 is improved since the above-described tube unit 8 is provided. Consequently, durability of the hollow fiber deaeration module 5 can be improved, and the liquid supplied to the first through-flow channel 15 can be prevented from leaking to the space outside the plurality of tubes 7.

Operation of the liquid-borne fine particle counting system of the invention is described based on FIG. 1.

The liquid-borne fine particle counting system 1 is configured to supply a liquid for fine particle counting (liquid to be measured) from the supply source 3 thereof. In such a configuration, the liquid to be measured is supplied to the liquid-borne fine particle counting system 1 from the supply source 3.

Although the liquid to be measured is not particularly limited, examples thereof include an organic solvent; water such as ion-exchanged water, pure water, and ultrapure water; a functionality-imparted liquid obtained by dissolving an acid, an alkali, ozone, a surfactant, an organic solvent, or the like in any of these kinds of water; and supercritical water (water at a pressure of 22.1 MPa or more and a temperature of 374° C. or higher; pure water the surface tension of which is maximally reduced by adding carbon dioxide or a set of same and a chemical may be used). For example, the liquid to be measured may be a liquid supplied to wash an apparatus for producing a liquid crystal panel and a liquid supplied to wash an apparatus for producing a semiconductor wafer such as a silicon wafer or to perform cut process, and may be preferably ultrapure water.

Although the configuration of the upstream side of the supply source 3 is not particularly limited as long as it is a supply source of the liquid to be measured, the upstream side of the supply source 3 may be branched from piping in which the liquid flows and be connected so that part of the liquid can be subjected to fine particle counting, may be connected to a storage part, may be connected to a pressurization device such as a high-pressure washing machine, and may be configured, for example, such that a pressurized liquid (high pressure liquid) at a pressure of, for example, 3 MPa or more and 20 MPa or less is supplied.

The liquid-borne fine particle counting system 1 of the invention is configured to be connected to the first connector part 13 of the hollow fiber deaeration module 5 via the flow channel 4a for the liquid to be measured from the supply source 3. In such a configuration, the liquid to be measured supplied from the supply source 3 flows through the flow channel 4a and is supplied to the inside of the hollow fiber deaeration module 5 from the first connector part 13.

The closed container 9 of the hollow fiber deaeration module is configured such that a depressurization pump such as a vacuum pump is connected thereto via piping for deaeration. Consequently, the inner pressure is decreased by driving the depressurization pump and sending air from the inside (second region) of the closed container 9 to the outside of the closed container 9, and bubbles in the liquid to be measured and gas dissolved in the liquid to be measured are evaluated from the wetted surface (first region) of the tube 7.

The liquid-borne fine particle counting system 1 of the invention is configured such that the second connector part 14 of the hollow fiber deaeration module 5 is connected to the liquid-borne fine particle counter 2 via the flow channel 4b for the liquid to be measured. The liquid-borne fine particle counter 2 is configured to irradiate, with light, the liquid to be measured supplied from the liquid supply port of the liquid-borne fine particle counter 2 and detect scattering and reduction of the energy of the light to count the number of fine particles included in the liquid, and the number of fine particles included in the supplied liquid to be measured is counted and displayed on a display unit. The liquid to be measured deaerated by the hollow fiber deaeration module 5 is thus sent from the second connector part 14 to the liquid-borne fine particle counter 2 via the flow channel 4b, and the number of fine particles included in the liquid to be measured is counted. The rated flow rate of the liquid-borne fine particle counter 2 used in the invention is not particularly limited, and is preferably 11 mL/min or less and more preferably 10.5 mL/min or less and is preferably 9.5 mL/min or more.

The liquid-borne fine particle counter 2 is configured to send the liquid to be measured to the outside of the system via a flow channel 4c from the liquid discharge port of the liquid-borne fine particle counter 2. The liquid-borne fine particle counter 2 may be configured such that the liquid to be measured discharged from the liquid discharge port of the liquid-borne fine particle counter 2 flows inside the system through suctioning from the downstream side of the system using a liquid sending pump connected to the middle of the flow channel 4c. The flow rate and the pressure can also be adjusted by connecting, on the downstream side of the discharge port, a flow rate adjustment device or a pressure adjustment device instead of the liquid sending pump or in addition to the liquid sending pump further via the flow channel 4c. The liquid to be measured discharged from the liquid discharge port may be connected to the downstream side of the supply source again, and may be discarded to a drain.

The liquid-borne fine particle counting system 1 of the invention can be used for cases of counting the number of particles included in, for example, a liquid supplied to wash an apparatus for producing a liquid crystal panel, a liquid supplied to wash an apparatus for producing a semiconductor wafer such as a silicon wafer or to perform cut process, and preferably ultrapure water.

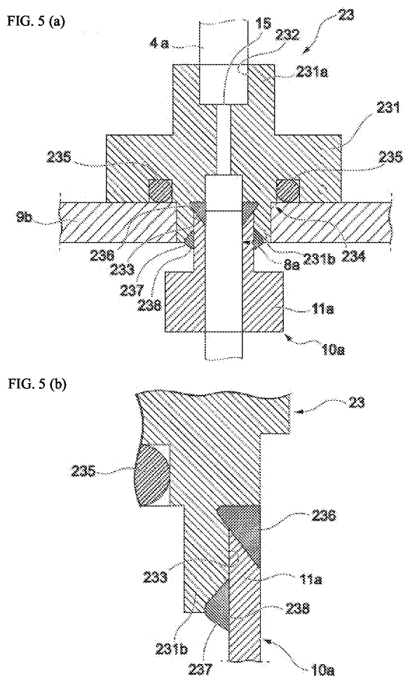

FIG. 5(a) is a schematic cross-sectional view illustrating a modification of the first connector part 13 of FIG. 3(a), and FIG. 5(b) is an enlarged partial cross-sectional view.

As illustrated in FIG. 5(a) and FIG. 5(b), the first connector part 23 has a first connector part main body 231 in which a first through-flow channel 15 is formed, a first concave part 232 which is provided to one end part 231a of the first connector part main body 231 in relation to an axis line direction of the first through-flow channel 15 and to which a flow channel 4a on the liquid supply source 3 side is connected, a second concave part 233 which is provided to the other end part 231b of the first connector part main body 231 and to which one end part 8a of the tube unit 8 is connected, and an engaging part 234 provided in an outer peripheral part of the first connector part main body 231.

The first connector part 23 may have a first seal part 235 such as an O ring disposed between the first connector part main body 231 and the closed container 9. When the first seal part 235 is composed of an O ring, the O ring is preferably disposed in an annular groove part or the like formed in the first connector part main body 231. The arrangement position of the first seal part 235 is not particularly limited, and can be provided above the lid part 9b, for example. Consequently, airtightness between the first connector part 23 and the closed container 9 can be further improved. The material for the O ring may be a known material, and examples thereof include rubber such as nitrile rubber, fluoro-rubber, silicone rubber, ethylene propylene rubber, chloroprene rubber, urethane rubber, and hydrogenated nitrile rubber; and fluororesin.

Additionally, the first connector part 23 may have a second seal part 236 disposed in the second concave part 233. The second seal part 236 can be composed of a ferrule, for example. In this case, it is preferable that a female thread part and a male thread part be provided to the second concave part 233 and to the outer cylinder 11a constituting the bundling part 10a, respectively, and a helix structure formed from the second concave part 233 and the outer cylinder 11a be provided, for example. Strong joint is provided by the above-described ferrule and the helix structure, and high airtightness is obtained by deformation of the second seal part 236.

The first connector part 23 may further have a notch part 237 provided in the other end part 231b of the first connector part main body 231 and an annular third seal part 238 disposed in the notch part 237. The form of the notch part 237 is not particularly limited, and may be C-chamfering, for example, is preferably formed in an annual shape. The third seal part 238 is not particularly limited, and may be composed of a resin material including an epoxy-based resin such as an adhesive and a fluororesin such as PFA or may be composed of a metal such as a welded metal. Joint performance and airtightness between the first connector part 23 and the tube unit 8 can be further improved by the above-described configuration.

In addition, the first connector part 23 may have one or more of the first seal part, the second seal part, and the third seal part. Consequently, joint performance and airtightness between the first connector part 23 and the closed container 9 and joint performance and airtightness between the first connector part 23 and the tube unit 8 can be further improved.

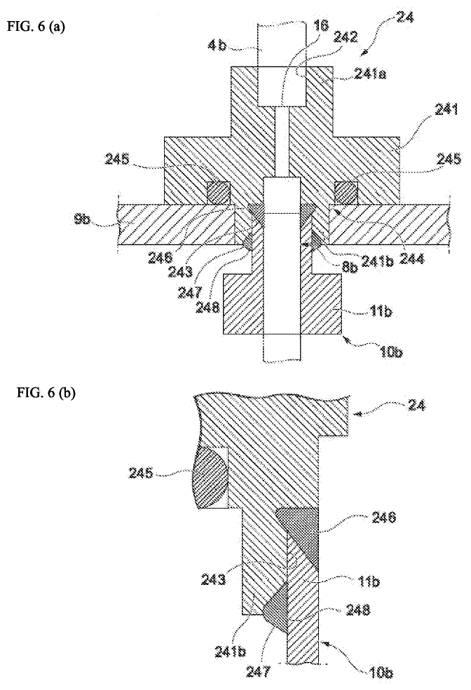

FIG. 6(a) is a schematic cross-sectional view illustrating a modification of the second connector part 14 of FIG. 3(b), and FIG. 6(b) is an enlarged partial cross-sectional view.

As illustrated in FIG. 6(a) and FIG. 6(b), the second connector part 24 has a second connector part main body 241 in which a second through-flow channel 16 is formed, a first concave part 242 which is provided to one end part 21a of the second connector part main body 241 in relation to an axis line direction of the second through-flow channel 16 and to which a flow channel 4b connected to the liquid introduction port of the liquid-borne fine particle counter is connected, a second concave part 243 which is provided to the other end part 241b of the second connector part main body 241 and to which one end part 8b of the tube unit 8 is connected, and an engaging part 244 provided in an outer peripheral part of the second connector part main body 241.

The second connector part 24 may have a first seal part 245 such as an O ring disposed between the second connector part main body 241 and the closed container 9. When the first seal part 245 is composed of an O ring, the O ring is preferably disposed in an annular groove part or the like formed in the second connector part main body 241. The arrangement position of the first seal part 245 is not particularly limited, and can be provided above the lid part 9b, for example. Consequently, airtightness between the second connector part 24 and the closed container 9 can be further improved.

In addition, the second connector part 24 may have a second seal part 246 disposed in the second concave part 243. The second seal part 246 can be composed of a ferrule, for example. In this case, it is preferable that a female thread part and a male thread part be provided to the second concave part 243 and to the outer cylinder 11b constituting the bundling part 10b, respectively, and a helix structure formed from the second concave part 243 and the outer cylinder 11b be provided, for example. Strong joint is provided by the above-described ferrule and the helix structure, and high airtightness is obtained by deformation of the second seal part 246.

The second connector part 24 may further have a notch part 247 provided in the other end part 241b of the second connector part main body 241 and an annular third seal part 248 disposed in the notch part 247. The form of the notch part 247 is not particularly limited, and may be C-chamfering, for example, is preferably formed in an annual shape. The third seal part 248 is not particularly limited, and may be composed of a resin material including an epoxy-based resin such as an adhesive and a fluororesin such as PFA or may be composed of a metal such as a welded metal.

Joint performance and airtightness between the second connector part 24 and the tube unit 8 can be further improved by the above-described configuration.

In addition, as in the case of the first connector part 23, the second connector part 24 may have one or more of the first seal part, the second seal part, and the third seal part.

Consequently, joint performance and airtightness between the second connector part and the closed container 9 and joint performance and airtightness between the second connector part and the tube unit 8 can be further improved.

### REFERENCE SIGNS LIST

1: Liquid-borne fine particle counting system
2: Liquid-borne fine particle counter (particle counter)
3: Liquid (liquid to be measured) supply source
4a, 4b, 4c: Flow channel
5: Hollow fiber deaeration module
6: Suction pump
6a: Piping for deaeration
7: Tube
8: Tube unit
9: Closed container
9a: Container main body

9b: Lid part
9c: Liquid introduction port
9d: Liquid discharge port
10a, 10b: Bundling part
11a, 11b: Outer cylinder
12a, 12b: Sealing part
13, 23: First connector part
14: Second connector part
15: First through-flow channel
16: Second through-flow channel
20: Suction port
131: First connector part main body
131a: One end part
131b: Other end part
132: First concave part
133: Second concave part
134: Engaging part
141: Second connector part main body
141a: One end part
141b: Other end part
142: Third concave part
143: Fourth concave part
144: Engaging part
231: First connector part main body
231a: One end part
231b: Other end part
232: First concave part
233: Second concave part
234: Engaging part
235: First seal part
236: Second seal part
237: Notch part
238: Third seal part
241: Second connector part main body
241a: One end part
241b: Other end part
242: First concave part
243: Second concave part
244: Engaging part
245: First seal part
246: Second seal part
247: Notch part
248: Third seal part

1. A liquid-borne fine particle counting system, comprising: a liquid-borne fine particle counter; and at least one hollow fiber deaeration module connected to a flow channel between a supply source of a liquid for fine particle counting and a liquid introduction port of the liquid-borne fine particle counter, wherein
the hollow fiber deaeration module has
a closed container,
a tube unit disposed in the closed container and composed of one tube or by bundling two or more tubes,
a first connector part disposed at a liquid introduction port of the closed container so as to penetrate through an inside and an outside of the closed container and engaged with the closed container, and
a second connector part disposed at a liquid discharge port of the closed container so as to penetrate through the inside and the outside of the closed container and engaged with the closed container;
one end part of the tube or the tube unit is airtightly connected to the first connector part;
the other end part of the tube or the tube unit is airtightly connected to the second connector part; and
the tube is formed from one or more kinds selected from an amorphous fluoropolymer, polytetrafluoroethylene, and polymethyl pentene.

2. The liquid-borne fine particle counting system according to claim 1, wherein
the first connector part or the second connector part is formed from one or more kinds selected from: an amorphous fluororesin including a copolymer obtained from tetrafluoroethylene and perfluoro-2,2-dimethyl-1,3-dioxol comonomers; a tetrafluoroethylene resin; and a polymethylpentene resin.

3. The liquid-borne fine particle counting system according to claim 1, wherein
surface roughness Ra of a wetted surface of the tube is 0.25 μm or less, and the tube has a gas permeability coefficient falling within a range of 5×10^{-6 [}cm³·cm/cm²·sec·cmHg] to 1×10^{-9 [}cm³·cm/cm²·sec·cmHg].

4. The liquid-borne fine particle counting system according to claim 1, wherein
the first connector part has: a first connector part main body in which a first through-flow channel is formed; a first concave part which is provided to one end part of the first connector part main body in relation to an axis line direction of the first through-flow channel and to which a flow channel on a liquid supply source side is connected; a second concave part which is provided to the other end part of the first connector part main body and to which one end part of the tube unit is connected; and an engaging part provided in an outer peripheral part of the first connector part main body.

5. The liquid-borne fine particle counting system according to claim 4, wherein
the first connector part has at least one seal part selected from the group consisting of: a first seal part disposed between the first connector part main body and the closed container; a second seal part disposed in the second concave part; and a notch part provided in the other end part of the first connector part main body and an annular third seal part disposed in the notch part.

6. The liquid-borne fine particle counting system according to claim 1, wherein
the second connector part has: a second connector part main body in which a second through-flow channel is formed; a first concave part which is provided to one end part of the second connector part main body in relation to an axis line direction of the second through-flow channel and to which a flow channel connected to the liquid introduction port of the liquid-borne fine particle counter is connected; a second concave part which is provided to the other end part of the second connector part main body and to which one end part of the tube unit is connected; and an engaging part provided in an outer peripheral part of the second connector part main body.

7. The liquid-borne fine particle counting system according to claim 6, wherein
the second connector part has at least one seal part selected from the group consisting of: a first seal part disposed between the second connector part main body and the closed container; a second seal part disposed in the second concave part; and a notch part provided in the other end part of the second connector part main body and an annular third seal part disposed in the notch part.

8. A liquid-borne fine particle counting method, comprising
counting fine particles in a liquid using the liquid-borne fine particle counting system according to claim 1.

9. A hollow fiber deaeration module used for a liquid-borne fine particle counting system, the hollow fiber deaeration module comprising:
a closed container,
a tube unit disposed in the closed container and composed of one tube or by bundling two or more tubes,
a first connector part disposed at a liquid introduction port of the closed container so as to penetrate through an inside and an outside of the closed container and engaged with the closed container, and
a second connector part disposed at a liquid discharge port of the closed container so as to penetrate through the inside and the outside of the closed container and engaged with the closed container, wherein
one end part of the tube or the tube unit is airtightly connected to the first connector part;
the other end part of the tube or the tube unit is airtightly connected to the second connector part; and
the tube is formed from one or more kinds selected from an amorphous fluoropolymer, polytetrafluoroethylene, and polymethyl pentene.

10. A liquid-borne fine particle counting method, comprising
counting fine particles in a liquid using the liquid-borne fine particle counting system according to claim 2.

11. A liquid-borne fine particle counting method, comprising
counting fine particles in a liquid using the liquid-borne fine particle counting system according to claim 3.

12. A liquid-borne fine particle counting method, comprising
counting fine particles in a liquid using the liquid-borne fine particle counting system according to claim 4.

13. A liquid-borne fine particle counting method, comprising
counting fine particles in a liquid using the liquid-borne fine particle counting system according to claim 5.

14. A liquid-borne fine particle counting method, comprising
counting fine particles in a liquid using the liquid-borne fine particle counting system according to claim 6.

15. A liquid-borne fine particle counting method, comprising
counting fine particles in a liquid using the liquid-borne fine particle counting system according to claim 7.
